(19) United States
(12) Patent Application Publication
(10) Pub. No.: US 2014/0062176 A1
(43) Pub. Date: Mar. 6, 2014

(54) Brake Control Apparatus

(71) Applicant: Hitachi Automotive Systems, Ltd., Hitachinaka-shi (JP)

(72) Inventors: Shinichiro NISHIDA, Zama-shi (JP); Atsushi MATSUOKA, Hadano-shi (JP); Yusuke FUJII, Atsugi-shi (JP)

(73) Assignee: Hitachi Automotive Systems, Ltd., Hitachinaka-shi (JP)

(21) Appl. No.: 14/011,108

(22) Filed: Aug. 27, 2013

(30) Foreign Application Priority Data
Aug. 28, 2012 (JP) 2012-187472

(51) Int. Cl. B60T 13/58

(52) U.S. Cl. CPC B60T 13/586
USPC 303/3

(57) ABSTRACT

A brake control apparatus includes a normally-open pressure-buildup control valve disposed between a master cylinder and each wheel-brake cylinder, a reservoir into which the brake fluid in each of the wheel-brake cylinders flows during an anti-brake skid pressure-reduction control mode, and a pressure-reduction control valve disposed between each of the wheel-brake cylinders and the reservoir. Also provided is a fluid-pressure controller configured to bring the pressure-buildup control valve to a non-controlled state and simultaneously bring the pressure-reduction control valve to a controlled state, when flowing and storing the brake fluid, flown out of the master cylinder due to a driver's brake-pedal operation, into the reservoir and when flowing and storing the brake fluid in each of the wheel-brake cylinders into the reservoir, during braking with an electric-regenerative braking system brought to an operative state.

### TECHNICAL FIELD

The present invention relates to a brake control apparatus.

### BACKGROUND ART

In recent years, there have been proposed and developed various brake control technologies in which a master-cylinder pressure and a wheel cylinder pressure for each individual wheel-brake cylinder are controlled or regulated by operating a plurality of valves during operation of an electric-regenerative braking system. One such brake control technology has been disclosed in Japanese Unexamined Patent Application Publication No. 2007-500104 (hereinafter is referred to as “JP2007-500104”), corresponding to U.S. Pat. No. 8,123,310, issued on Feb. 28, 2012. In the brake control technologies, utilizing an electric-regenerative braking system as well as a fluid-pressure friction braking system, as disclosed in JP2007-500104, more-improved control accuracy would be desirable.

### SUMMARY OF THE INVENTION

Accordingly, it is an object of the invention to provide an improved brake control apparatus configured to greatly enhance the control accuracy.

In order to accomplish the aforementioned and other objects of the present invention, a brake control apparatus of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control apparatus comprises a normally-open pressure-buildup control valve disposed between a master cylinder and each of the wheel-brake cylinders, a reservoir into which the brake fluid in each of the wheel-brake cylinders flows during an anti-brake skid pressure-reduction control mode, a pressure-reduction control valve disposed between each of the wheel-brake cylinders and the reservoir, and a fluid-pressure controller configured to bring the pressure-buildup control valve to a non-controlled state and simultaneously bring the pressure-reduction control valve to a controlled state, when flowing and storing the brake fluid, flown out of the master cylinder due to a driver's brake-pedal operation, into the reservoir and when flowing and storing the brake fluid in each of the wheel-brake cylinders into the reservoir, during braking with the electric-regenerative braking system brought to an operative state.

According to another aspect of the invention, a brake control apparatus of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control apparatus comprises a pump disposed in a hydraulic brake circuit, a first brake circuit configured to connect a master cylinder provided for generating a brake-fluid pressure due to a driver's brake-pedal operation to each of the wheel-brake cylinders configured such that the brake-fluid pressure, generated by the master cylinder, acts on each of the wheel-brake cylinders, a second brake circuit configured to connect the first brake circuit to a discharge port of the pump, a normally-open gate-out valve disposed in the first brake circuit between the master cylinder and a joining point of the first brake circuit and the second brake circuit, a third brake circuit configured to connect a point of the first brake circuit between the normally-open gate-out valve and the master cylinder to an inlet port of the pump, a normally-open pressure-buildup control valve disposed in the first brake circuit between each of the wheel-brake cylinders and the joining point of the first brake circuit and the second brake circuit, a fourth brake circuit configured to connect a point of the first brake circuit between each of the wheel-brake cylinders and the normally-open pressure-buildup control valve to the inlet port of the pump, a normally-closed pressure-reduction control valve disposed in the fourth brake circuit, a reservoir disposed in the fourth brake circuit between the inlet port of the pump and the normally-closed pressure-reduction control valve, and configured to connected to the third brake circuit, and a fluid-pressure controller configured to permit the brake fluid, flown out of the master cylinder due to the driver's brake-pedal operation, and the brake fluid in each of the wheel-brake cylinders to be directed to the reservoir, by controlling only the normally-closed pressure-reduction control valve of these valves, during braking with the electric-regenerative braking system brought to an operative state.

According to a further aspect of the invention, a brake control method of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control method comprises driving one control valve when flowing and storing the brake fluid, flown out of the master cylinder due to a driver's brake-pedal operation, into a reservoir.

The other objects and features of this invention will become understood from the following description with reference to the accompanying drawings.

### BRIEF DESCRIPTION OF THE DRAWINGS

FIG. 1 is a system diagram illustrating a system configuration of a braking/driving system for a hybrid vehicle to which an embodiment of a brake control apparatus is applied.

FIG. 2 is a hydraulic brake circuit diagram illustrating details of a hydraulic brake circuit of the brake control apparatus of the embodiment.

FIG. 3 is a longitudinal cross-sectional view illustrating a pneumatic booster including a master cylinder.

FIG. 4 is an enlarged cross-sectional view illustrating the essential part of the pneumatic booster shown in FIG. 3, under a state where the stroke of an input rod is within a predetermined stroke range corresponding to a predetermined play and thus there is no brake-fluid pressure produced by pistons in the master cylinder.

FIG. 5 is an enlarged cross-sectional view illustrating the essential part of the pneumatic booster shown in FIG. 3, under a state where the input-rod stroke exceeds the predetermined stroke range and thus the master-cylinder pistons are pushed to the left and thus hydraulic pressure (master-cylinder pressure) develops in the master cylinder, and then a reaction, or “push-back”, force, which is proportional to the fluid pressure developing in the master cylinder, is transmitted to the input rod.

FIG. 6 is a characteristic diagram illustrating input and output characteristics of the pneumatic booster.

FIGS. 7A-7F are time charts illustrating a control action of a hydraulic control unit during energy-regeneration cooperative control when the driver is depressing a brake pedal BP in a low- and mid-speed range.

FIG. 8 is a hydraulic brake circuit diagram illustrating brake-fluid flow when the driver is depressing the brake pedal BP in a low- and mid-speed range.

FIG. 9 is a hydraulic brake circuit diagram illustrating brake-fluid flow during execution of substitution control by which a regenerative braking force is substituted with a friction braking force.

FIGS. 10A-10F are time charts illustrating a control action of the hydraulic control unit during energy-regeneration cooperative control when the brake pedal BP is released by the driver.

FIGS. 11A-11F are time charts illustrating a control action of the hydraulic control unit during energy-regeneration cooperative control when the brake pedal BP is further depressed by the driver.

FIGS. 12A-12F are time charts illustrating a control action of the hydraulic control unit during energy-regeneration cooperative control when the driver is depressing the brake pedal BP in a high-speed range.

FIG. 13 is a hydraulic brake circuit diagram illustrating brake-fluid flow during execution of substitution control by which a friction braking force is substituted with a regenerative braking force.

### DESCRIPTION OF THE PREFERRED EMBODIMENTS

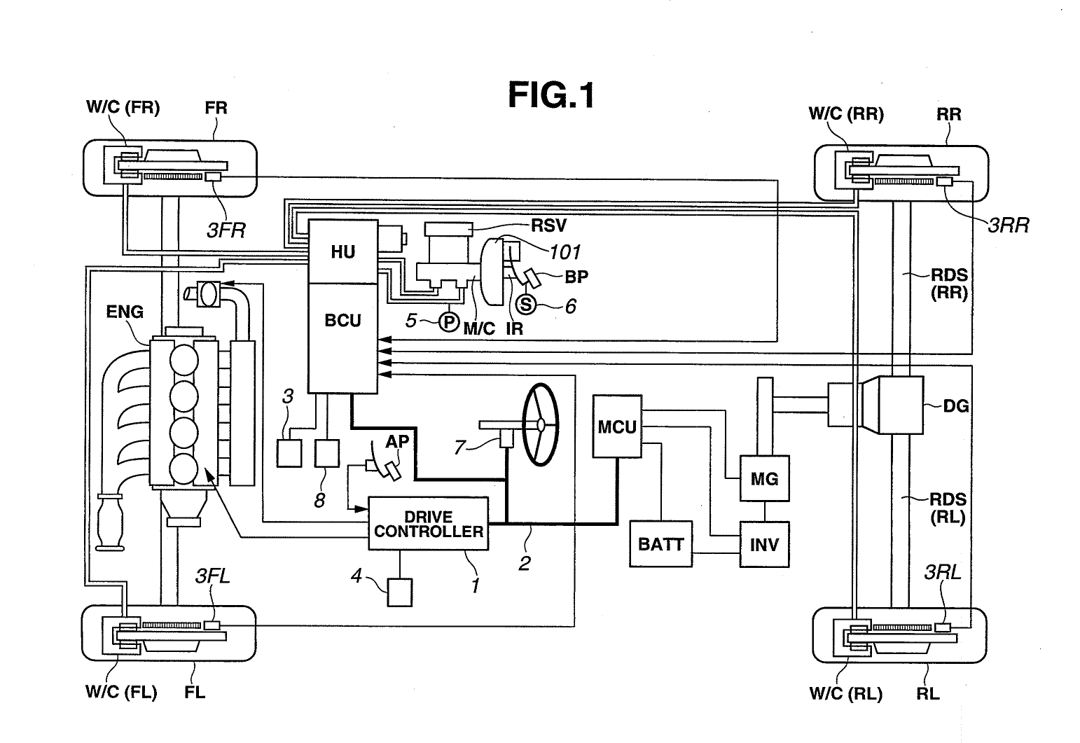

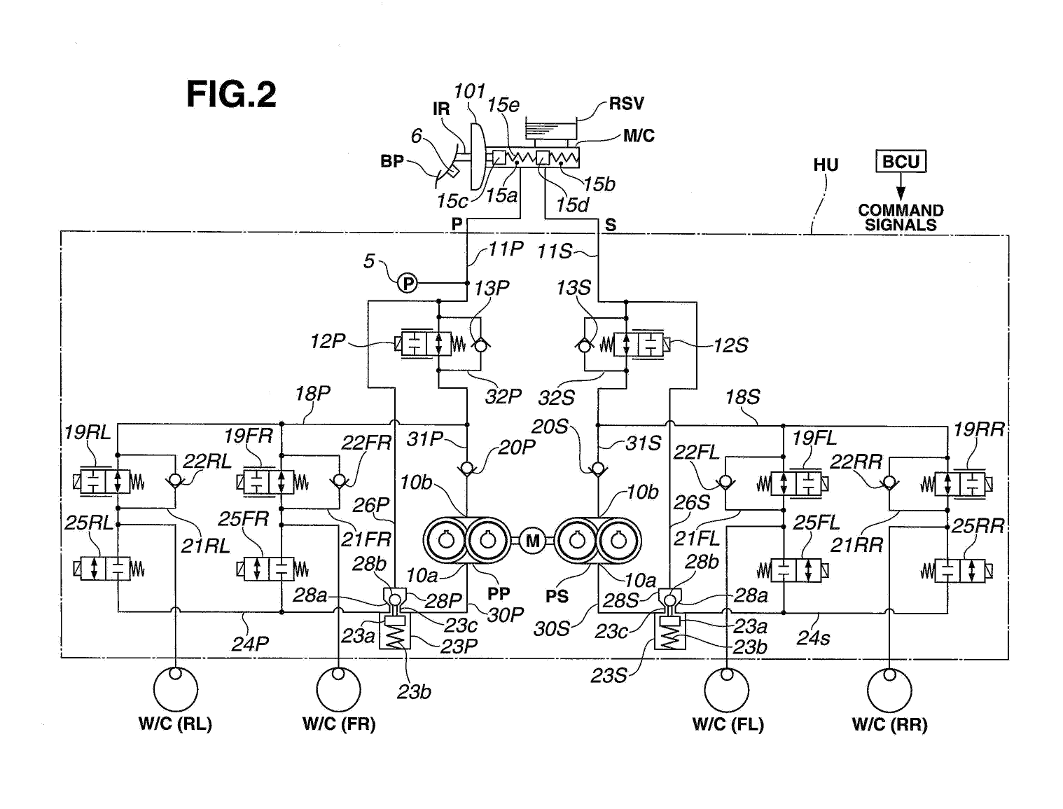

Referring now to the drawings, particularly to FIGS. 1-2, the brake control apparatus of the embodiment is exemplified in a hybrid vehicle. The brake control apparatus of the embodiment is configured to adapt itself to much needs. The enhancement of a brake-control accuracy is one of these needs considered. As hereunder described in detail, the brake control apparatus of the embodiment is also configured to satisfy the other needs, for instance the enhancement of a brake-pedal “feel”.

FIG. 1 shows the system configuration of a braking/driving system of a hybrid vehicle to which the brake control apparatus of the embodiment is applied, whereas FIG. 2 shows the hydraulic brake circuit diagram of the brake control apparatus of the embodiment.

### [System Configuration]

A hydraulic control unit HU is configured to regulate (build up, reduce, or hold), responsively to command signals from a brake control unit (a fluid-pressure controller) BCU, respective fluid pressures in a front-left wheel-brake cylinder W/C (FL), a rear-right wheel-brake cylinder W/C (RR), a front-right wheel-brake cylinder W/C (FR), and a rear-left wheel-brake cylinder W/C (RL). That is, a fluid-pressure friction braking system, which is configured to control a brake fluid pressure in each wheel-brake cylinder W/C installed on road wheels for generating a braking force resulting from braking torque application to each road wheel, is constructed by hydraulic control unit HU and brake control unit BCU.

A motor generator MG is a three-phase alternating current motor. Motor generator MG is connected via a differential gear DG to a rear-left driveshaft RDS (RL) for the rear-left road wheel RL and a rear-right driveshaft RDS (RR) for the rear-right road wheel RR. The operating mode of motor generator MG is switched between a power-running mode and an energy-regeneration mode, in response to a command from a motor control unit MCU. With the motor generator MG kept in the power-running mode, driving torque, produced by motor generator MG, is delivered via the differential gear DG to the rear road wheels RL-RR. In contrast, with the motor generator MG kept in the energy-regeneration mode, an electric-regenerative braking force (energy-regeneration braking torque) is applied to the rear road wheels RL-RR.

An inverter INV is configured for converting a direct-current (dc) power of a battery BATT into an alternating-current (ac) power, responsively to a command from the motor control unit MCU, and for supplying the dc-ac converted power to the motor generator MG so as to operate the motor generator MG in the power-running mode. Inverter INV is also configured for converting an ac power, generated by the motor generator MG, into a dc power, responsively to a command from the motor control unit MCU, so as to charge the battery BATT with the motor generator MG operating in the energy-regeneration mode.

Motor control unit MCU is configured to output a command to the inverter INV in response to a command from a drive controller 1. Motor control unit MCU is also configured to output a command to the inverter INV in response to a command from the brake control unit BCU.

Motor control unit MCU is further configured to send information about an output control state (i.e., an operating mode) of motor generator MG operating in either one of the power-running mode (a driving-torque application mode) and the energy-regeneration mode (a regenerative-braking-force application mode) and a maximum regenerative braking force that can be generated at the current control cycle, via a communication line 2, such as a controller area network (CAN) communications line, to both the brake control unit BCU and the drive controller 1. Hereon, the previously-discussed “maximum regenerative braking force that can be generated” is calculated or derived from (i) a state of battery charge (SOC) estimated based on a battery's terminal voltage and a value of electric current flowing through the battery BATT and (ii) a vehicle-body speed (i.e., a vehicle speed) calculated or estimated based on sensor signals from wheel-speed sensors 3. By the way, during turns, the “maximum regenerative braking force that can be generated” is calculated, fully taking account of vehicle handling characteristics as well as the estimated battery's state of charge (SOC) and the calculated vehicle speed.

That is, in the case of the fully-charged battery that the battery's state of charge (SOC) is approximately an upper limit, from the viewpoint of battery protection, an undesirable overcharge has to be prevented. Also, in the case that the vehicle speed decreases owing to a braking effect, the maximum regenerative braking force that can be generated by motor generator MG tends to reduce. Furthermore, when regenerative braking is carried out during running of the vehicle at high speeds, the inverter INV tends to be overloaded. To avoid this, during high-speed operation of the vehicle, the maximum regenerative braking force has to be restricted or the regenerative braking action has to be inhibited.

Additionally, in the case of the vehicle to which the brake control apparatus of the embodiment is applied, owing to the regenerative braking force applied to the rear road wheels, during turns the magnitude of regenerative braking force tends to be remarkably greater than that of friction braking force, that is, the magnitude of braking force applied to the rear road wheels tends to be remarkably greater than that applied to the front road wheels. In such a case, the vehicle handling characteristics become remarkable oversteer tendencies. This means a disorder of cornering behavior of the vehicle. To avoid this, in other words, to avoid oversteer tendencies from undesirably developing, the maximum regenerative braking force has to be properly restricted, such that a braking-force distribution between front road wheels FL-FR and rear road wheels RL-RR during turns can be brought closer to an ideal braking-force distribution (for instance, Front Braking Force:Rear Braking Force=6:4) depending on the vehicle specifications.

As discussed above, an electric-regenerative braking system, which is configured to generate a regenerative braking force applied to the road wheels (i.e., rear-left and rear-right road wheels RL-RR), is constructed by motor generator MG, inverter INV, battery BATT, and motor control unit MCU.

Drive controller 1 is configured to receive input information about an accelerator pedal position detected by an accelerator pedal position sensor 4, a vehicle speed (i.e., a vehicle-body speed) calculated based on sensor signals from wheel-speed sensors 3, a state of battery charge (SOC), and the like, directly or via the communication line 2.

Drive controller 1 is also configured to execute, based on input informational data from respective engine/vehicle sensors, various operational controls, that is, operational control of an engine ENG, operational control of an automatic transmission (not shown), and operational control of motor generator MG, based on a command outputted from the drive controller 1 to the motor control unit MCU.

Brake control unit BCU is configured to receive input information about a master-cylinder pressure detected by a master-cylinder pressure sensor 5, a brake-pedal stroke detected by a brake-pedal stroke sensor 6, a steering-wheel rotation angle detected by a steering-wheel rotation angle sensor 7, wheel speeds detected by wheel-speed sensors 3 (rear-left, front-right, front-left and rear-right wheel-speed sensors 3RL, 3FR, 3FL, and 3RR), a yaw rate detected by a yaw rate sensor 8, a state of battery charge (SOC), and the like, directly or via the communication line 2.

Brake control unit BCU is configured to calculate, based on information about the master-cylinder pressure and the brake-pedal stroke, a driver's required braking force necessary for the vehicle, and also configured to divide the calculated driver's required braking force into a regenerative braking force and a friction braking force. Brake control unit BCU outputs a command to the motor control unit MCU to obtain or achieve the calculated regenerative braking force, and simultaneously brake control unit BCU controls the operation of hydraulic control unit HU to obtain or achieve the calculated friction braking force.

Hereon, in the shown embodiment, during energy-regeneration cooperative control, a higher priority is put on the regenerative braking force rather than the friction braking force, such that the driver's required braking force can be provided with the regenerative braking force generated by the electric-regenerative braking system, as much as possible, rather than using the friction braking force generated by the fluid-pressure friction braking system, that is, the regenerative-braking-force range can be enlarged to the previously-discussed maximum regenerative braking force that can be generated. Hence, even in a specific running pattern that vehicle acceleration and vehicle deceleration repeatedly occur, it is possible to attain a high energy-recovery efficiency. Additionally, energy-regeneration (energy-recovery) to lower vehicle speeds can be realized by means of the electric-regenerative braking system, which is operating more efficiently. By the way, in the case that during energy-regeneration cooperative control (simply, during regenerative braking) the regenerative braking force is restricted because of a vehicle-speed drop/rise, brake control unit BCU operates to ensure or achieve the driver's required braking force as a whole by decreasing the regenerative braking force and by substituting or supplementing such a decrease in the regenerative braking force with an increase in the friction braking force. Conversely in the case that the restriction on the regenerative braking force has been removed, brake control unit BCU operates to ensure or achieve the driver's required braking force as a whole by increasing the regenerative braking force and by substituting or supplementing such an increase in the regenerative braking force with a decrease in the friction braking force.

### [Fluid-Pressure Brake System Hydraulic Brake Circuit]

As best seen in FIG. 2, hydraulic control unit HU of the brake control apparatus of the embodiment uses a so-called dual circuit brake system comprised of a primary-side brake-line system (a “P” hydraulic circuit) and a secondary-side brake-line system (an “S” hydraulic circuit). That is, hydraulic control unit HU of the shown embodiment adopts a so-called diagonal split layout of brake circuits, sometimes termed “X-split layout”, in which one part of a tandem master cylinder output is connected via the “P” brake-line system to rear-left wheel-brake cylinder W/C (RL) and front-right wheel-brake cylinder W/C (FR) and the other part is connected via the “S” brake-line system to rear-right wheel-brake cylinder W/C (RR) and front-left wheel-brake cylinder W/C (FL). As appreciated from the hydraulic brake circuit shown in FIG. 2, “P” and “S”, added to reference sign ends, respectively denote a primary-side and a secondary-side in the dual circuit brake system. “RL”, “FR”, “FL”, and “RR”, added to reference sign ends, respectively denote a component included in a rear-left road wheel side, a component included in a front-right road wheel side, a component included in a front-left road wheel side, and a component included in a rear-right road wheel side. In the following description, only in the presence of necessity of discrimination between the “P” brake-line system and the “S” brake-line system, the characters “P” and “S” are added. In the absence of necessity of discrimination among component parts included in respective road wheels RL, FR, FL, and RR, the characters “RL”, “FR”, “FL”, and “RR” are not added. For instance, rear-left, front-right, front-left and rear-right wheel-brake cylinders W/C (RL), W/C (FR), W/C (FL), and W/C (RR) are collectively referred to as “W/C”.

Hydraulic control unit HU of the shown embodiment uses a closed hydraulic circuit. Hereon, the technical term “closed hydraulic circuit” means a hydraulic brake circuit that brake fluid, supplied to wheel-brake cylinders W/C, shall be returned via a master cylinder M/C to a reservoir tank RSV. A brake pedal BP is connected via an input rod IR to the master cylinder M/C. A pneumatic booster (a booster) 101, which utilizes a pneumatic actuator as a braking-power multiplication source, is installed on the input rod IR for multiplying an input applied to the input rod IR by a driver's brake-pedal operation. Details of operation and construction of pneumatic booster 101 are described later.

Master cylinder M/C is a tandem master cylinder with two pistons in tandem, namely, a primary piston 15c and a secondary piston 15d arranged in tandem to define a primary chamber 15a and a secondary chamber 15b. When the brake pedal BP is not depressed, each of primary and secondary pistons 15c-15d is pushed by a spring force (an elastic force) of a spring 15e disposed between the two pistons 15c-15d, such that the brake pedal BP can be returned to its initial position. The primary chamber 15a is connected to the “P” brake-line system, whereas the secondary chamber 15b is connected to the “S” brake-line system.

Reservoir tank RSV is configured to connect with each of the primary chamber 15a and the secondary chamber 15b via respective brake-fluid conduits (not shown) with the brake pedal BP held at its initial position. That is, depending on the input-rod stroke, reservoir tank RSV serves to supply brake fluid to within the master cylinder M/C and also serves to store surplus brake fluid from within the master cylinder M/C.

As appreciated from the left-hand half of the hydraulic brake circuit shown in FIG. 2, front-right wheel-brake cylinder W/C (FR) and rear-left wheel-brake cylinder W/C (RL) are connected to the “P” brake-line system. As appreciated from the right-hand half of the hydraulic brake circuit shown in FIG. 2, front-left wheel-brake cylinder W/C (FL) and rear-right wheel-brake cylinder W/C (RR) are connected to the “S” brake-line system. Also, a pump PP is disposed in the “P” brake-line system, whereas a pump PS is disposed in the “S” brake-line system. For instance, in the shown embodiment, each of pumps PP-PS is a gear pump P. These gear pumps are driven by means of a common electric motor M. In operation, each of gear pumps PP-PS pressurizes brake fluid introduced through an inlet port 10a and discharges the pressurized brake fluid from a discharge port 10b.

Master cylinder M/C and the discharge port 10b of pump P are connected with each other by way of a conduit (a brake-fluid line) 11 and a conduit 31 (a second brake circuit). A gate-out valve 12 is disposed in the conduit 11. Gate-out valve 12 is a normally-open, solenoid-operated proportional valve, which is configured to be held at its fully-open position when de-energized and also configured to be displaced toward its closed position when energized. A bypass line 32 is connected to the conduit 11 in a manner so as to bypass the gate-out valve 12. A check valve 13 is disposed in the bypass line 32. Check valve 13 permits brake-fluid flow from the master cylinder M/C toward the wheel-brake cylinder W/C and prevents (inhibits) any brake-fluid flow in the opposite direction.

A check valve 20 is disposed in the conduit 31. Check valve 20 permits brake-fluid flow from the pump P toward the conduit 11, and prevents (inhibits) any brake-fluid flow in the opposite direction.

The discharge port 10b of pump P and the wheel-brake cylinder W/C are connected to each other by way of a conduit 18. A solenoid-in valve 19 is disposed in the conduit 18, such that front-right solenoid-in valve 19FR is associated with front-right wheel-brake cylinder W/C (FR) and that rear-right solenoid-in valve 19RR is associated with rear-right wheel-brake cylinder W/C (RR). Solenoid-in valve 19 is a normally-open solenoid-operated proportional valve (a pressure-buildup control valve), which is configured to be held at its fully-open position when de-energized and also configured to be displaced toward its closed position when energized. Conduits 11 and 18 construct a first brake circuit. A bypass line 21 is connected to the conduit 18 in a manner so as to bypass the solenoid-in valve 19. A check valve 22 is disposed in the bypass line 21. Check valve 22 permits brake-fluid flow from the wheel-brake cylinder W/C toward the pump P and prevents any brake-fluid flow in the opposite direction. Conduit 18 is connected to the junction (the joining point) of conduits 11 and 31.

Each wheel-brake cylinder W/C and a reservoir 23 are connected to each other by way of a conduit 24. A solenoid-out valve 25 is disposed in the conduit 24. Solenoid-out valve 25 is a normally-closed, solenoid-operated proportional valve (a pressure-reduction control valve), which is configured to be held at its fully-closed position when de-energized and also configured to be displaced toward its open position when energized. Conduits 24 and 30 construct a fourth brake circuit.

Master cylinder M/C and reservoir 23 are connected to each other by way of a conduit 26. Also, reservoir 23 and the inlet port 10a of pump P are connected to each other by way of a conduit 30. Conduits 26 and 30 construct a third brake circuit.

Reservoir 23 is comprised of a piston 23a and a spring 23b for forcing or biasing the piston 23a toward a spring-loaded position (i.e., an initial position). Reservoir 23 is also equipped with a pressure-sensitive check valve 28 disposed in the conduit 26. Check valve 28 includes a seat portion 28a formed at a fluid port (an inflow port) 23c of reservoir 23 and a valve element (e.g., a ball) 28b configured to be brought into abutted-engagement with the seat portion 28a mainly depending on the hydraulic pressure in the conduit 26. Valve element 28b is formed integral with the piston 23a. More concretely, when a predetermined amount of brake fluid has been stored in the reservoir 23 or when the fluid pressure in the conduit 26 exceeds a predetermined pressure value (a predetermined high-pressure level), the valve element 28b is seated on the seat portion 28a against the spring load of the spring 23b and thus the check valve 28 is shifted to its valve-closed position at which the incoming brake-fluid flow into the reservoir 23 can be inhibited. Hence, high-pressure application to the inlet port 10a of pump P can be prevented. By the way, in the case that the fluid pressure in the conduit 30 becomes low with the pump P operating, the valve element 28b of check valve 28 lifts from the seat portion 28a owing to the fluid-pressure reduction in the conduit 30 regardless of the fluid-pressure level in the conduit 26, and thus the check valve 28 becomes shifted to a valve-open position at which the incoming brake-fluid flow into the reservoir 23 can be permitted.

### [ABS Control]

Immediately when the brake control unit BCU detects a wheel lock-up tendency (or a skidding condition) during the driver's brake-pedal depression, the brake control unit BCU performs anti-lock brake control or anti-brake skid (ABS) control by which a pressure reduction, a pressure hold, and a pressure buildup for the wheel cylinder pressure in wheel-brake cylinder W/C of the skidding road wheel almost stopped turning or entering a locked-up mode are repeatedly executed to provide maximum effective braking, while preventing wheel lock-up.

During an ABS pressure-reduction control mode, the solenoid-in valve 19 is shifted from the original position (the normally-open position shown in FIG. 2) to the closed position, whereas the solenoid-out valve 25 is shifted from the original position (the normally-open position shown in FIG. 2) to the open position, such that the wheel cylinder pressure is reduced by directing the brake fluid in this wheel-brake cylinder W/C to the reservoir 23. During an ABS pressure-hold control mode, the solenoid-in valve 19 and the solenoid-out valve 25 are both kept closed, such that the wheel cylinder pressure is held constant. During an ABS pressure-buildup control mode, the solenoid-in valve 19 is kept open and the solenoid-out valve 25 is kept closed, such that the wheel cylinder pressure is built up by supplying the brake fluid stored in the reservoir 23 to the wheel-brake cylinder W/C. When a regenerative braking force is generated during skid control (or with the ABS system shifted to its operative state), in other words, during energy-regeneration cooperative control, substitution control is executed such that the regenerative braking force becomes reduced to zero and in lieu thereof the friction braking force becomes rapidly risen for substitution of the regenerative braking force with the friction braking force.

By the way, in the shown embodiment, hydraulic control unit HU is configured to execute vehicle dynamic-behavior stability control (vehicle dynamics control), brake-assist control, and automatic brake control, in addition to the ABS control as previously discussed. According to the vehicle dynamics control, when it has been detected or determined that oversteer or understeer tendencies are remarkably developing, the vehicle dynamic-behavior can be stabilized by operating the valves and the pumps and by controlling or regulating the wheel cylinder pressure of the controlled road wheel subjected to the vehicle dynamics control. According to the brake-assist control, a wheel cylinder pressure higher than the pressure level of the hydraulic pressure (the master-cylinder pressure) developed in the master cylinder M/C can be generated during the driver's brake-pedal depression. Also, according to the automatic brake control, for instance, a braking force can be automatically generated depending on the relative relation between a host vehicle and preceding vehicles, such as the host vehicle's distance from and relative speed to preceding vehicles, by auto-cruise control (or adaptive cruise control).

### [Construction of Pneumatic Booster]

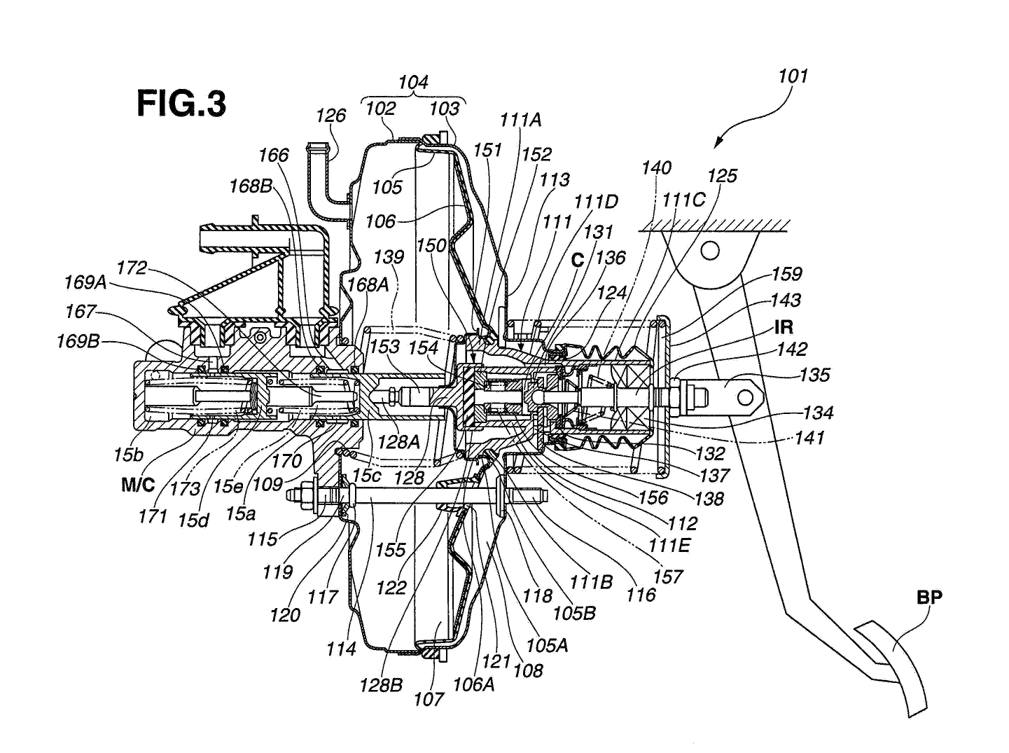

Referring now to FIG. 3, there is shown the longitudinal cross-section of the pneumatic booster 101 including the master cylinder M/C.

Pneumatic booster 101 includes a housing 104 comprised of a front shell 102 and a rear shell 103 integrally connected to each other. Each of front and rear shells 102-103 is formed of a thin metal sheet. The internal space in the housing 104 is sectioned into a constant-pressure chamber 107 and a variable-pressure chamber 108 by a power piston 106 with a diaphragm 105. Each of front and rear shells 102-103 has a substantially cylindrical shape. Front and rear shells 102-103 have respective bottoms axially facing each other. More concretely, the opening edge of the outer periphery of rear shell 103 is integrally fitted to the opening edge of the outer periphery of front shell 102, while sandwiching the diaphragm lip of diaphragm 105 between these edges in a pressure-tight fashion (in an airtight fashion).

Master cylinder M/C is installed on the center of front shell 102, such that the rear end of master cylinder M/C is inserted into the central opening 109 of the bottom of front shell 102. The bottom of rear shell 103 is formed at its center with a rear cylindrical portion 112 configured to protrude axially rearward. A valve body 111 (described later) is inserted into the opening end of rear cylindrical portion 112. Also, the bottom of rear shell 103 has a substantially annular rear seating surface 113 formed along the circumference of the rear cylindrical portion 112 and brought into abutted-engagement with a dash panel or a bulkhead (not shown) of the vehicle body.

A tie rod 114 is attached to the housing 104 in a manner so as to extend from the front shell 102 toward the rear shell 103 and penetrate the rear seating surface 113. Tie rod 114 is formed at both ends with a mounting screw-threaded portion 115 and a fixed screw-threaded portion 116. Also, tie rod 114 has a front flange 117 and a rear flange 118 integrally formed to be diametrically enlarged at respective axially innermost ends of screw-threaded portions 115-116. When assembling, front flange 117 is brought into abutted-engagement with the inside of the bottom of front shell 102 via a retainer 119 and a seal 120 in an airtight fashion, whereas rear flange 118 is fixedly connected to the rear shell 103 by caulking, while being kept in abutted-engagement with the inside of the rear seating surface 113 in an airtight fashion. The intermediate portion of tie rod 114 is inserted into both the opening 121 formed in the power piston 106 and a substantially cylindrical rod seal 122 formed integral with the diaphragm 105, in a manner so as to permit a sliding motion of tie rod 114 relative to both the power piston 106 and the diaphragm 105, while keeping a gas-tightness between the constant-pressure chamber 107 (the left-hand side of diaphragm 105) and the variable-pressure chamber 108 (the right-hand side of diaphragm 105).

Although only one tie rod 114 is shown in FIG. 3, actually, two tie rods 114, 114 are provided in diametrically-opposed two places of the shell pair 102-103. The mounting screw-threaded portions 115, 115 of tie rods 114, 114 serve to mount the master cylinder M/C on the front shell 102, whereas the fixed screw-threaded portions 116, 116 of tie rods 114, 114 serve to mount the rear seating surface 113 of rear shell 103 onto the dash panel (not shown) of the vehicle body. Although it is not shown in FIG. 3, in addition to the fixed screw-threaded portions 116, rear mounting studs (not shown) are further fixedly connected to the rear seating surface 113 of rear shell 103 by caulking, such that the rear seating surface 113 is more certainly fixedly connected onto the dash panel.

Valve body 111 is formed at its front end with a substantially cylindrical diametrically-enlarged portion (simply, a front-end cylindrical portion) 111A. The front-end cylindrical portion 111A of valve body 111 is inserted into both the central opening 106A of power piston 106 and the central opening 105A of diaphragm 105. Also, valve body 111 has a substantially cylindrical boss portion 111E, which is arranged coaxially with and formed integral with the front-end cylindrical portion 111A. The inner peripheral portion 105B of the central opening 105A of diaphragm 105 is fitted to an outer peripheral annular groove 111B of valve body 111, such that the inner periphery of diaphragm 105 and the outer periphery of valve body 111 are connected to each other in a gastight fashion. Valve body 11 is also formed at its rear end with a small-diameter cylindrical portion 111C. The small-diameter cylindrical portion 1110 of valve body 111 is configured to pass through part of the variable-pressure chamber 108 and also configured to be inserted into the rear cylindrical portion 112 of rear shell 103 in a manner so as to extend toward the exterior. A seal 124 is installed onto the inner peripheral wall of rear cylindrical portion 112 in a manner so as to permit an axial sliding motion of the small-diameter cylindrical portion 111C of valve body 111 relative to the rear cylindrical portion 112 of rear shell 103, while keeping a gas-tightness between the inner periphery of rear cylindrical portion 112 and the small-diameter cylindrical portion 111C. A bellows-shaped dust cover (a dust boot) 125 is installed to hermetically cover the outer periphery of the small-diameter cylindrical portion 111C in a manner so as to extend over its entire length. The substantially cylindrical-hollow leftmost end of bellows dust cover 125 is fitted onto the outer periphery of the opening end of rear cylindrical portion 112. One end of a vacuum connecting pipe 126 is connected to the front shell 102 (i.e., the constant-pressure chamber 107), whereas the other end of vacuum connecting pipe 126 is connected to a negative-pressure source (not shown), such as an intake manifold of engine ENG. Thus, the given negative pressure (e.g., the intake-manifold vacuum) is always applied to the constant-pressure chamber 107 so as to maintain the pressure in the constant-pressure chamber 107 at a given negative pressure.

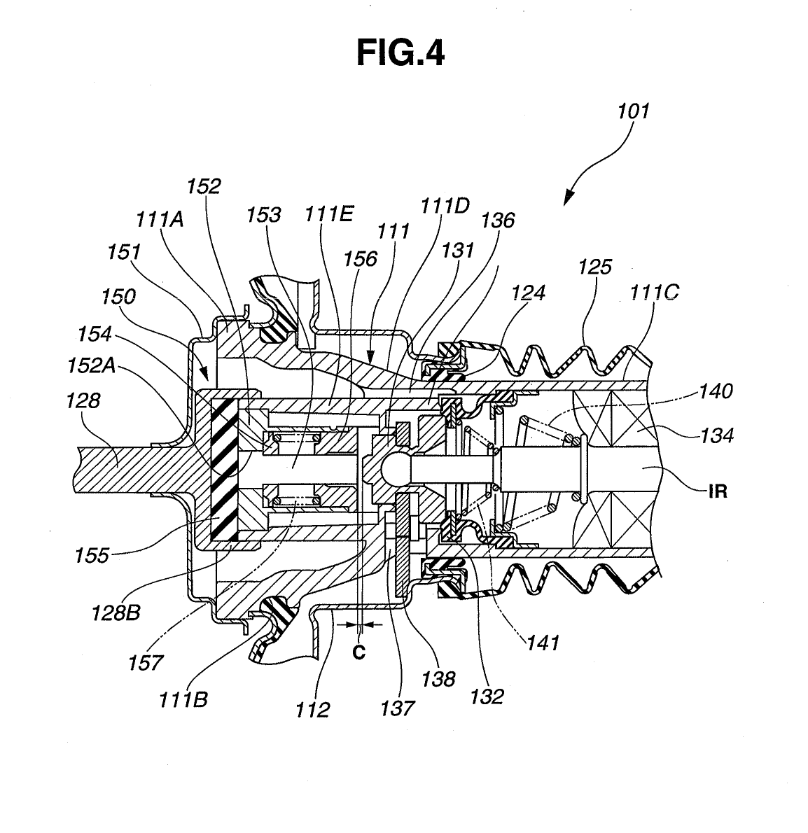

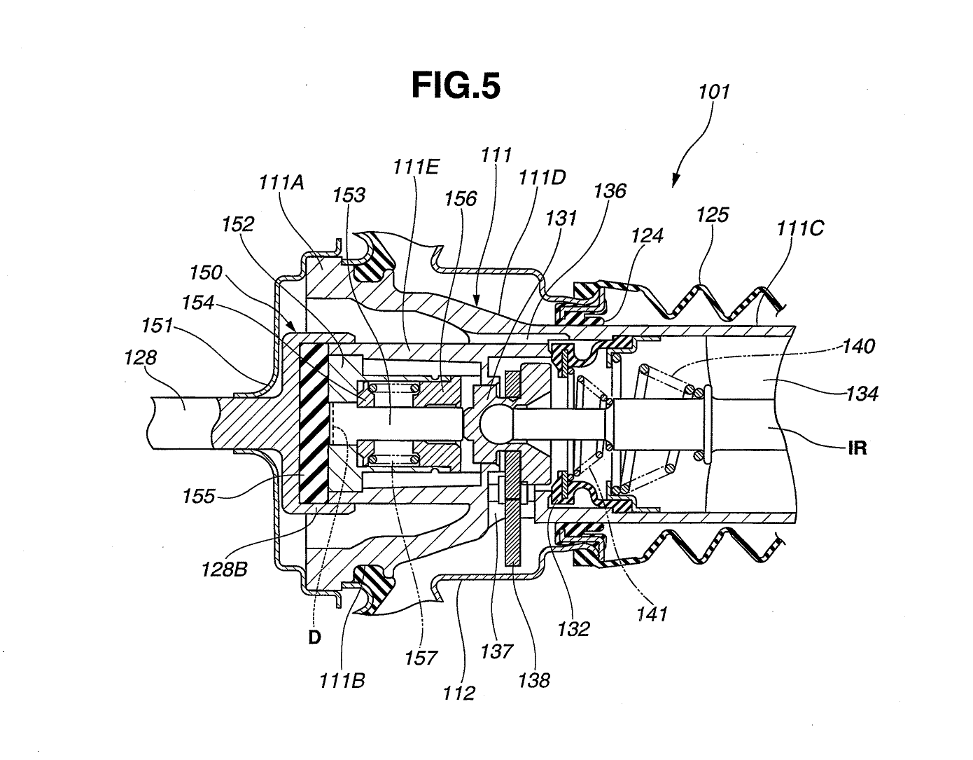

As seen in FIGS. 3-5, a reaction adjustment mechanism 150 is provided at the front-end cylindrical portion 111A of valve body 111. Valve body 111 is configured such that a thrust of valve body 111 is transmitted via the reaction adjustment mechanism 150 to an output rod 128. As shown in FIG. 3, the tip 128A of output rod 128 is configured to abut with the primary piston 15c. On the other hand, as shown in FIGS. 4-5, the basal end (the root) 128B of output rod 128 is formed as a cup-shaped section in which a disk-shaped reaction member 155, made of elastic material, is housed. Hence, output rod 128 is configured to receive an axial force from the reaction adjustment mechanism 150 through the reaction member 155, and also configured to permit a reaction force from the master cylinder M/C to be transmitted toward or fed back to the reaction adjustment mechanism 150.

As clearly shown in FIG. 4, reaction adjustment mechanism 150 includes a diaphragm spring receiving member 151, a reaction receiving member 152, and a stepped rod-shaped reaction transmission member 153. Diaphragm spring receiving member 151 is fitted and fixedly connected to the front-end cylindrical portion 111A of valve body 111. A diaphragm spring 139 is disposed between the diaphragm spring receiving member 151 and the rear end of master cylinder M/C. The front end of reaction receiving member 152 is fitted and fixedly connected to the boss portion 111E of valve body 111. The stepped rod-shaped reaction transmission member 153 is axially movably housed in the reaction receiving member 152 (serving as a casing for reaction transmission member 153). Reaction receiving member 152 is formed into a substantially cylindrical-hollow shape. The front end face of reaction receiving member 152 is kept in abutted-engagement with the right-hand sidewall surface of the disk-shaped reaction member 155. The stepped rod-shaped reaction transmission member 153 includes a comparatively large-diameter head portion and a comparatively small-diameter shank portion. The front end (i.e., the large-diameter head portion) of reaction transmission member 153 is axially slidably fitted into a center axial through hole 152A formed in the front end of reaction receiving member 152. A substantially annular movable spring seat 154 and a substantially annular shank guide 156 are slidably fitted onto the outer periphery of the small-diameter shank portion of reaction transmission member 153. The forward axial movement of spring seat 154 is restricted by abutment of spring seat 154 with the stepped section between the large-diameter head portion and the small-diameter shank portion of reaction transmission member 153. Shank guide 156 is fixedly connected to the rear end of reaction receiving member 152 by caulking, for guiding the small-diameter shank portion of reaction transmission member 153. Reaction transmission member 153 is forced or biased toward the reaction member 155 by the spring force of a reaction adjustment spring 157 (e.g., a compression coil spring) disposed between the movable spring seat 154 and the shank guide 156.

A plunger 131 is inserted into the small-diameter cylindrical portion 111C of valve body 111. Plunger 131 is axially slidably placed in the diametrically-enlarged hollow portion of valve body 111 defined between the front-end cylindrical portion 111A and the small-diameter cylindrical portion 111C. The outer periphery of the disk-shaped front end of plunger 131 is closely fitted in the cylindrical bore formed in the partition wall of the boss portion 111E coaxially arranged with the front-end cylindrical portion 111A, in a manner so as to permit an axial sliding motion of plunger 131 relative to the valve body 111, while ensuring a gas-tight seal between the outer periphery of the disk-shaped front end of plunger 131 and the inner periphery of the cylindrical bore of the partition wall of the boss portion 111E of valve body 111. The small-diameter disk-shaped axial protrusion, further axially protruded from the disk-shaped front end of plunger 131, and the rear end of the small-diameter shank portion of reaction transmission member 153 are axially opposed each other with a specified axial clearance C (hereinafter referred to as a “jump-in clearance”). The front end of input rod IR is inserted into the opening of the rear end of the small-diameter cylindrical portion 111C of valve body 111, and then the hemispherical axial end (the tip) of input rod IR is mechanically linked and connected to the plunger 131. The basal end of input rod IR is configured to extend to the exterior, while penetrating a dust seal 134 having a gas permeability and fitted into the rear end of the small-diameter cylindrical portion 111C of valve body 111. As best seen in FIG. 3, a clevis 135 is installed on the basal end of input rod IR, such that the input rod IR is mechanically linked to the brake pedal BP through the clevis 135. Also placed in the small-diameter cylindrical portion 111C of valve body 111 is a control valve 132 whose opening and closing can be controlled depending on the axial position of plunger 131 relative to the valve body 111. Control valve 132 is forced toward its valve-closed direction by a valve spring 141 whose right-hand end is seated on the stepped portion of input rod IR.

An axially-extending constant-pressure passage 136 and a radial-extending variable-pressure passage 137 are formed in a substantially frustoconical tapered wall portion 111D of valve body 111 between the front-end cylindrical portion 111A and the small-diameter cylindrical portion 111C. Constant-pressure passage 136 is configured to communicate with the constant-pressure chamber 107, whereas variable-pressure passage 137 is configured to communicate with the variable-pressure chamber 108. Depending on a relative displacement of the plunger 131 to the valve body 111, control valve 132 serves to switch between (i) a connection (i.e., a vacuum-port-open state) of the constant-pressure passage 136 to the variable-pressure passage 137 and (ii) a disconnection (i.e., a vacuum-port-closed state) of the constant-pressure passage 136 from the variable-pressure passage 137, and also serves to switch between (i) a connection (i.e., an atmospheric-port-open state) of the atmospheric-pressure side (the side of dust seal 134) to the variable-pressure passage 137 and (ii) a disconnection (i.e., an atmospheric-port-closed state) of the atmospheric-pressure side (the side of dust seal 134) from the variable-pressure passage 137.

For instance, under an inoperative state where the brake pedal BP is not depressed, fluid-communication between the variable-pressure passage 137 (the variable-pressure chamber 108) and the constant-pressure passage 136 (the constant-pressure chamber 107) and fluid-communication between the variable-pressure passage 137 (the variable-pressure chamber 108) and the atmospheric-pressure side (the side of dust seal 134) are both blocked (see FIG. 4).

In contrast, when the brake pedal BP is depressed and thus the plunger 131 is displaced forward relatively to the valve body 111, fluid-communication between the variable-pressure passage 137 and the atmospheric-pressure side (the side of dust seal 134) becomes established, while retaining fluid-communication between the variable-pressure passage 137 and the constant-pressure passage 136 (the constant-pressure chamber 107) blocked (see FIG. 5). At this time, the variable-pressure passage 137 becomes opened to the atmosphere via the dust seal 134.

A stop key 138 is installed or inserted into the radially-extending variable-pressure passage 137 formed in the frustoconical tapered wall portion 111D of valve body 111, for restricting the backward axial movement (the retreated position) of valve body 111 by abutted-engagement of the lower end of stop key 138 with the shouldered portion of rear cylindrical portion 112 of rear shell 103 (see FIG. 4). Additionally, the upper end of stop key 138 is loosely fitted into an annular groove formed in the outer periphery of plunger 131 such that stop key 138 is slightly axially movable in the annular groove of plunger 131. The upper end of stop key 138. loosely fitted into the annular groove of plunger 131, serves to properly restrict the relative displacement between the plunger 131 and the valve body 111.

A return spring 140 is placed in the small-diameter cylindrical portion 111C of valve body 111, for biasing the input rod IR toward its retreated position (an input-rod original position). The rear end of input rod IR is fastened or fixedly connected to the clevis 135 by means of a nut 142. In addition to the return spring 140, a reaction spring 159 is disposed between a reaction spring receiver 143 and the rear seating surface 113 of rear shell 103, for biasing the input rod IR toward the retracted position (the input-rod original position). The backward axial movement of reaction spring receiver 143 is restricted by the nut 142.

Regarding the structure of master cylinder M/C, the secondary piston 15d, having a cup-shaped longitudinal cross section, is slidably fitted into the bottom end (the left-hand side closed end, viewing FIG. 3) of the cylindrical bore of master cylinder M/C, and the substantially cylindrical primary piston 15c, whose front end is formed to have a cup-shaped longitudinal cross section slidably fitted into the rear opening end of master cylinder M/C. The rear end of the primary piston 15c is configured to axially protrude rearward from the rear opening end of master cylinder M/C, and also configured to abut with the tip of output rod 128 in the constant-pressure chamber 107.

Two reservoir ports 166-167 are formed in the upper wall portion of the master-cylinder housing, for connecting the primary chamber 15a and the secondary chamber 15b via respective reservoir ports to the reservoir RSV. To provide a good fluid-tight sealing action, seals 168A-168B are placed between the cylindrical bore of master cylinder M/C and the outer periphery of the primary piston 15c, whereas seals 169A-169B are placed between the cylindrical bore of master cylinder M/C and the outer periphery of the secondary piston 15d. As clearly shown in FIG. 3, the two seals 168A-168B are axially spaced from each other in such a manner as to sandwich the primary-chamber side opening of the reservoir port 166. When the primary piston 15c is held in a non-braking position (see FIG. 3), the primary chamber 15a is communicated with the reservoir port 166 through a port 170 formed in the cup-shaped section of the primary piston 15c. Thereafter, when the primary piston 15c moves a predetermined stroke S1 (corresponding to a predetermined play that does not yet produce a master-cylinder pressure rise) forward from its non-braking position, the port 170 is closed by the seal 168B and thus fluid-communication between the primary chamber 15a and the reservoir port 166 becomes blocked and as a result hydraulic pressure starts to develop in the primary chamber 15a.

In a similar manner to the two seals 168A-168B, the two seals 169A-169B are axially spaced from each other in such a manner as to sandwich the secondary-chamber side opening of the reservoir port 167. When the secondary piston 15d is held in a non-braking position (see FIG. 3), the secondary chamber 15b is communicated with the reservoir port 167 through a port 171 formed in the cup-shaped section of the secondary piston 15b. Thereafter, when the secondary piston 15d moves a predetermined stroke S1 (corresponding to a predetermined play) forward from its non-braking position, the port 171 is closed by the seal 169B and thus fluid-communication between the secondary chamber 15b and the reservoir port 167 becomes blocked and as a result hydraulic pressure starts to develop in the secondary chamber 15b.

A spring assembly 172 (containing at least a spring retainer described later and the compression spring 15e shown in FIG. 2) is placed in the primary chamber 15a, and interleaved between the primary piston 15c and the secondary piston 15d. A return spring 173 (e.g., a compression coil spring) is placed in the secondary chamber 15b and interleaved between the closed end (the bottom end) of master cylinder M/C and the secondary piston 15d. Regarding the spring assembly 172, the compression coil spring is held at a given compressed state by means of the contractable/extendable spring retainer such that the distance of the secondary piston 15d relative to the primary piston 15c can be adjusted with the retainer contracted against the spring force of the compression coil spring. Usually, the secondary piston 15d together with the primary piston 15c moves axially at the same time, such that a hydraulic-pressure rise in the primary chamber 15a and a hydraulic-pressure rise in the secondary chamber 15b occur simultaneously.

### [Operation of Pneumatic Booster]

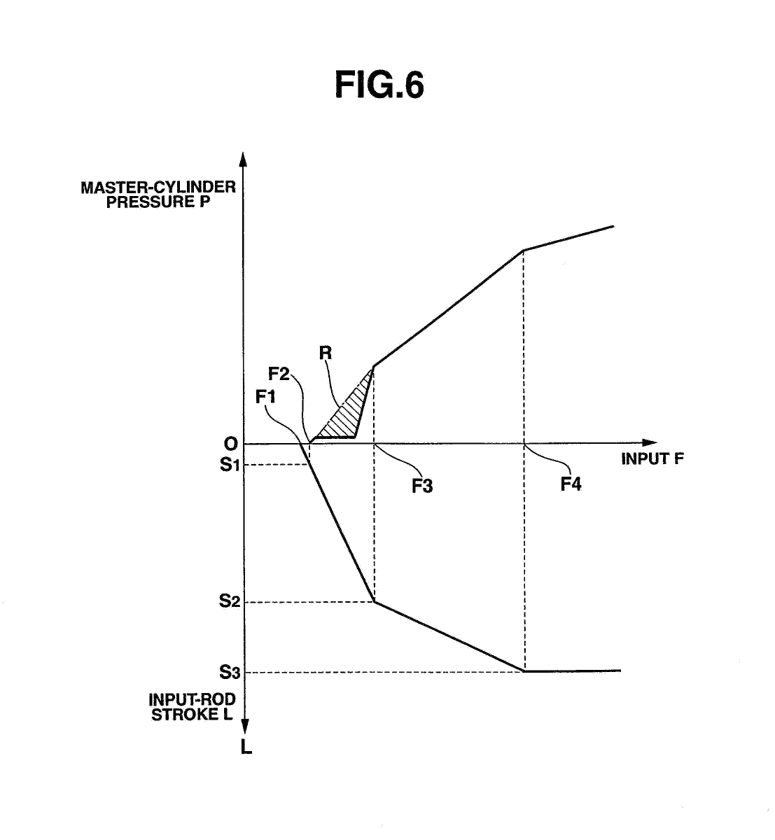

The operation of pneumatic booster 101 is hereunder described in detail. Referring to FIG. 6, there is shown the relationship among an input F to the input rod IR (in other words, a leg-power applied to the brake pedal BP by the driver), a fluid pressure in master cylinder M/C (simply, master-cylinder pressure P), and a rod stroke L of input rod IR (in other words, a brake-pedal stroke).

In the non-braking state (i.e., in the inoperative state of brake pedal BP) shown in FIG. 3, plunger 131 is held at its non-braking position (see FIG. 3) and thus the pressure (exactly, the negative pressure) in constant-pressure chamber 107 and the pressure (exactly, the negative pressure) in variable-pressure chamber 108 become equal to each other. Hence, there is no thrust applied to the power piston 106. Under these conditions, fluid-communication between the constant-pressure passage 136 (the constant-pressure chamber 107) and the variable-pressure passage 137 (the variable-pressure chamber 108) becomes blocked by means of the control valve 132 (see FIG. 4).

When the driver begins to press on the brake pedal BP and then the magnitude of an input applied to the input rod IR begins to exceed a first value F1 (see FIG. 6), plunger 131 moves forward by axial movement of input rod IR against the spring forces of return spring 140 and reaction spring 159. Thus, plunger 131 becomes displaced apart from the control valve 132 and hence the variable-pressure passage 137 becomes opened to the atmosphere such that atmospheric pressure is introduced into the variable-pressure chamber 108. As a result of this, a difference in pressure between the constant-pressure chamber 107 and the variable-pressure chamber 108 occurs. Owing to such a pressure difference, a thrust, applied to the power piston 106, occurs, thereby causing the valve body 111 to move forward. As a result, the thrust is transmitted through the reaction member 155 to the output rod 128, with the result that the primary piston 15c of master cylinder M/C is pushed by the output rod 128. Owing to the forward displacement of valve body 111, fluid-communication between the variable-pressure passage 137 and the atmospheric-pressure side (the side of dust seal 134) becomes blocked again by means of the control valve 132. Hence, the previously-noted pressure difference between the constant-pressure chamber 107 and the variable-pressure chamber 108, in other words, the thrust of power piston 106 can be maintained. In this manner, valve body 111 is displaced, while following an axial displacement of plunger 131.

Thereafter, when the brake pedal BP is further depressed by the driver and thus the magnitude of the input applied to the input rod IR increases (see the input F2 in FIG. 6), in other words, when the primary piston 15c moves the predetermined stroke S1, the ports 170 and 171 are closed by respective seals 168B and 169B. As a result, the hydraulic pressure in the primary chamber 15a and the hydraulic pressure in the secondary chamber 15b start to develop. Owing to the master-cylinder pressure developing, a reaction, or “push-back”, force from the master cylinder M/C acts on the valve body 111 through the reaction member 155 and the reaction receiving member 152. At this time, part of the reaction force also acts on the reaction transmission member 153 through the reaction member 155, but there is no sliding movement of the reaction transmission member 153, until such time that the magnitude of the reaction force acting on the reaction transmission member 153 reaches the spring force of the reaction adjustment spring 157. Additionally, by virtue of the jump-in clearance C between the rearmost end of reaction transmission member 153 and the small-diameter disk-shaped axial protrusion of plunger 131, the reaction force, arising from the master-cylinder pressure developing in the master cylinder M/C, does not yet act on the plunger 131. Only the reaction force, arising from the spring force of reaction spring 159, continuously acts on the brake pedal BP through the input rod IR and clevis 135. Hence, a good brake “feel” that does not depend on the hydraulic pressure in the master cylinder M/C can be maintained.

When the brake pedal BP is further depressed and thus the stroke of the primary piston 15c reaches a stroke S2, owing to a forward displacement of valve body 111, the hydraulic pressure in the master cylinder M/C further develops and rises and thus the magnitude of the reaction force, arising from the master-cylinder pressure, further increases. As a result, the magnitude of the reaction force, transmitted through the reaction member 155 to the reaction transmission member 153, exceeds the spring force of reaction adjustment spring 157. At this time, as seen in FIG. 5, the reaction transmission member 153 slightly moves back and thus the rearmost end of reaction transmission member 153 is brought into abutted-engagement with the small-diameter disk-shaped axial protrusion of plunger 131 (see the input F3 in FIG. 6). Therefore, part of the reaction force, arising from the hydraulic pressure in the master cylinder M/C, is transmitted to the plunger 131. As a result of this, the transmitted force is small, but part of the reaction force, arising from the hydraulic-pressure rise in the master cylinder M/C, can be certainly transmitted through the plunger 131 and the input rod IR to the brake pedal BP. Therefore, as compared to a brake “feel” obtained by only the reaction force, arising from the spring force of reaction spring 159, the summed reaction of (i) part of the reaction force, arising from the hydraulic-pressure rise in the master cylinder M/C, and (ii) the reaction force, arising from the spring force of reaction spring 159, can give the driver a more solid “feel” of braking action. Also, when the reaction is carried through the elastic reaction member 155 and the reaction transmission member 153 to the plunger 131, the elastic reaction member 155 deforms slightly and hence part of the center section of elastic reaction member 155 tends to swell to within the center axial through hole 152A of reaction receiving member 152. However, the amount of swell or deformation of the center section of elastic reaction member 155 can be suppressed by the spring force of reaction adjustment spring 157 and thus the amount of deformation of the elastic reaction member 155 is small.

Hereunder explained is the difference between the deformation of an elastic reaction member produced by a general non-reaction-transmission-member-equipped pneumatic booster and the deformation of the elastic reaction member 155 produced by the reaction-transmission-member-equipped pneumatic booster 101 of the embodiment having the reaction transmission member 153.

In the case of the general non-reaction-transmission-member-equipped pneumatic booster, when the brake pedal movement is stopped and the driver holds the brake pedal in a force-balanced braking position, the amount of swell/deformation of the center section of the elastic reaction member tends to reach a deformation corresponding to the so-called “jump-in clearance”, which clearance is defined by the specified axial clearance C. Assuming that the “jump-in clearance” is set to a large clearance, the amount of deformation of the elastic reaction member tends to increase to such degree as to be indicated by the vertical broken line “D” in FIG. 5.

In contrast, in the case of the reaction-transmission-member-equipped pneumatic booster 101 of the embodiment having the reaction transmission member 153, with the brake pedal BP held in a force-balanced braking position, the amount of swell/deformation of the center section of the elastic reaction member can be suppressed by the spring force of reaction adjustment spring 157. Hence, the amount of swell/deformation of the center section of elastic reaction member 155 tends to become smaller than a deformation corresponding to the so-called “jump-in clearance”, which clearance is defined by the specified axial clearance C.

As appreciated from the above, for the same “jump-in clearance”, the reaction-transmission-member-equipped pneumatic booster 101 of the embodiment enables an effectively suppressed or reduced amount of swell/deformation of elastic reaction member 155, in comparison with the general non-reaction-transmission-member-equipped pneumatic booster. Hence, the reaction-transmission-member-equipped pneumatic booster 101 of the embodiment has the advantage of increased durability of the elastic reaction member 155.

Thereafter, when the brake pedal BP is still further depressed and thus the stroke of the primary piston 15c reaches a stroke S3, in other words, a full-load point (see the input F4 in FIG. 6), a boosting ratio further reduces.

When the brake pedal BP is released, the input to the input rod IR is also released, the plunger 131 moves back, and as a result the variable-pressure passage 137 (the variable-pressure chamber 108) becomes communicated with the constant-pressure passage 136 (the constant-pressure chamber 107), while fluid-communication between the variable-pressure passage 137 and the atmospheric-pressure side is blocked by means of the control valve 132. Thus, the difference in pressure between the constant-pressure chamber 107 and the variable-pressure chamber 108 becomes zero and hence the thrust, applied to the power piston 106, becomes zero. As a result, the power piston 106 (the valve body 111), together with the plunger 131, moves back and thus the primary piston 15c returns back to its non-braking position (see FIG. 3).

As discussed previously, pneumatic booster 101 of the embodiment is configured to have a stroke control region, which is defined as a predetermined brake-pedal stroke range from a driver's brake-pedal operation start point where the driver begins to press on the brake pedal BP to the input-rod stroke S2 corresponding to the input-rod input F3. Within the stroke control region, the reaction force, arising from the master-cylinder pressure developing in the master cylinder M/C, does not act on the brake pedal BP, but only the reaction force, arising from the spring force of reaction spring 159, acts on the brake pedal BP. Thus, a relationship of the leg-power (i.e., the rod input F) applied to the brake pedal BP to the brake-pedal stroke (i.e., the input-rod stroke L) can be maintained at a preset or specified characteristic, regardless of the hydraulic pressure in the master cylinder M/C.

In the brake control apparatus of the embodiment, the regenerative braking force is set or preprogrammed to reach a maximum regenerative braking force limit value (i.e., an upper limit of the maximum regenerative braking force, determined by characteristics of motor generator MG) within the previously-discussed stroke control region. Hence, during energy-regeneration cooperative control, it is possible to maintain a good brake-pedal “feel” that does not depend on the hydraulic pressure in the master cylinder M/C.

### [Operation of Hydraulic Control Unit HU During Energy-Regeneration Cooperative Control]

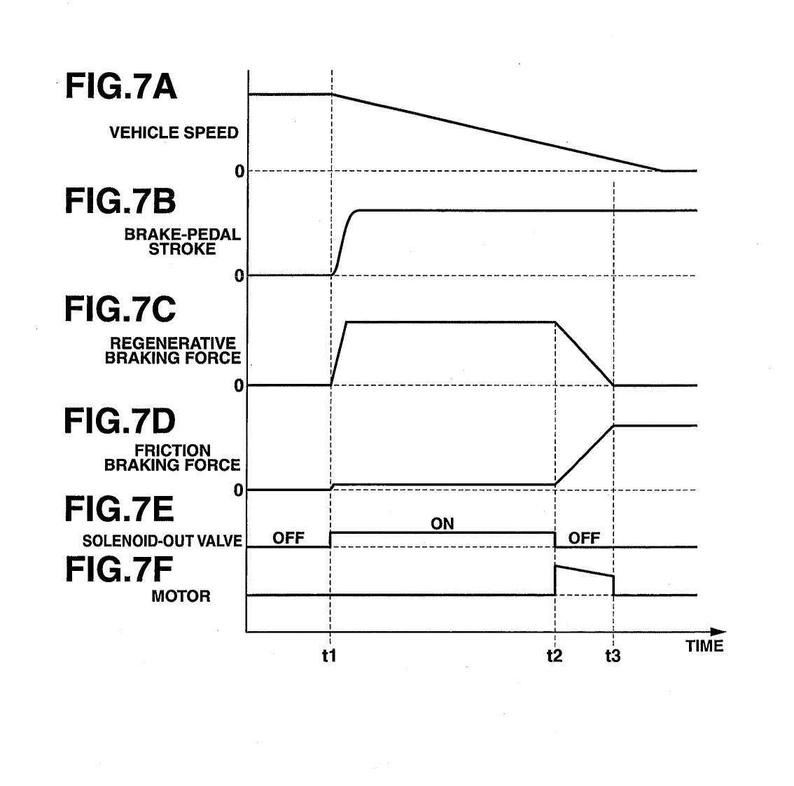

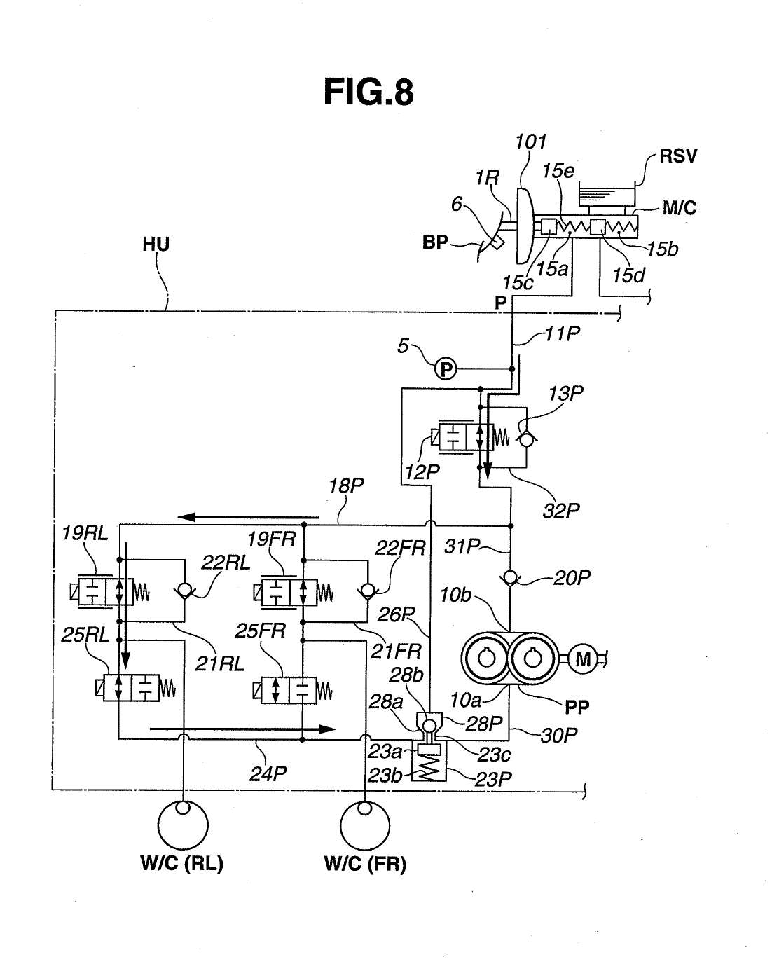

Hereunder described with reference to the time charts shown in FIGS. 7A-7F, 10A-10F, 11A-11F and 12A-12F, and the hydraulic brake circuit diagrams shown in FIGS. 8, 9 and 13 are the operation and control actions of hydraulic control unit HU, in various scenes occurred during energy-regeneration cooperative control. In the hydraulic brake circuit diagrams FIGS. 8, 9 and 13, the direction of brake-fluid flow is indicated by the heavy line with the arrow. For the purpose of simplification of the disclosure, in the hydraulic brake circuit diagrams FIGS. 8, 9 and 13, only the brake-fluid flow in the “P” brake-line system is shown, because the brake-fluid flows are the same in the “S” brake-line system and the “P” brake-line system.

Referring now to FIGS. 7A-7F, there are shown the time charts when the driver is depressing the brake pedal BP in a low- and mid-speed range during energy-regeneration cooperative control.

At the time t1, the driver begins to press on the brake pedal BP, thereby resulting in an increase in driver's required braking force. Thus, owing to such an increase in driver's required braking force, a rise in regenerative braking force occurs. At this time, as appreciated from the brake-fluid flow shown in FIG. 8, one solenoid-out valve 25RL of the solenoid-out valves 25FR-25RL (belonging to in the same brake-line system) incorporated in the hydraulic control unit HU becomes opened for flowing and storing the outgoing brake fluid, flown out of the master cylinder M/C, into the reservoir 23. Therefore, almost all of the driver's required braking force can be provided or covered by the regenerative braking force, and thus it is possible to enhance the energy-recovery efficiency (see the energy-regeneration/energy-recovery area “R” indicated as the left-hand diagonal shading area in FIG. 6). By the way, a slight friction braking force (i.e., an approximately constant wheel cylinder pressure) is also produced due to a residual fluid pressure in the reservoir 23. At this time, the brake-pedal stroke (i.e., the input-rod stroke L) is within the stroke control region of pneumatic booster 101, and thus the relationship between the brake-pedal stroke and the brake-pedal reaction force can be maintained constant, regardless of the master-cylinder pressure, thereby enabling a good brake-pedal “feel” to be maintained. As discussed above, at this time, only one (i.e., solenoid-out valve 25RL) of solenoid-out valves 25FR-25RL belonging to the same brake-line system, is opened. Hence, it is possible to reduce the number of control valves to be driven, as compared to a hydraulic system configuration such that two solenoid-out valves 25FR-25RL are simultaneously opened. This contributes to reduced noise and vibrations and also contributes to increased durability of hydraulic control unit HU.

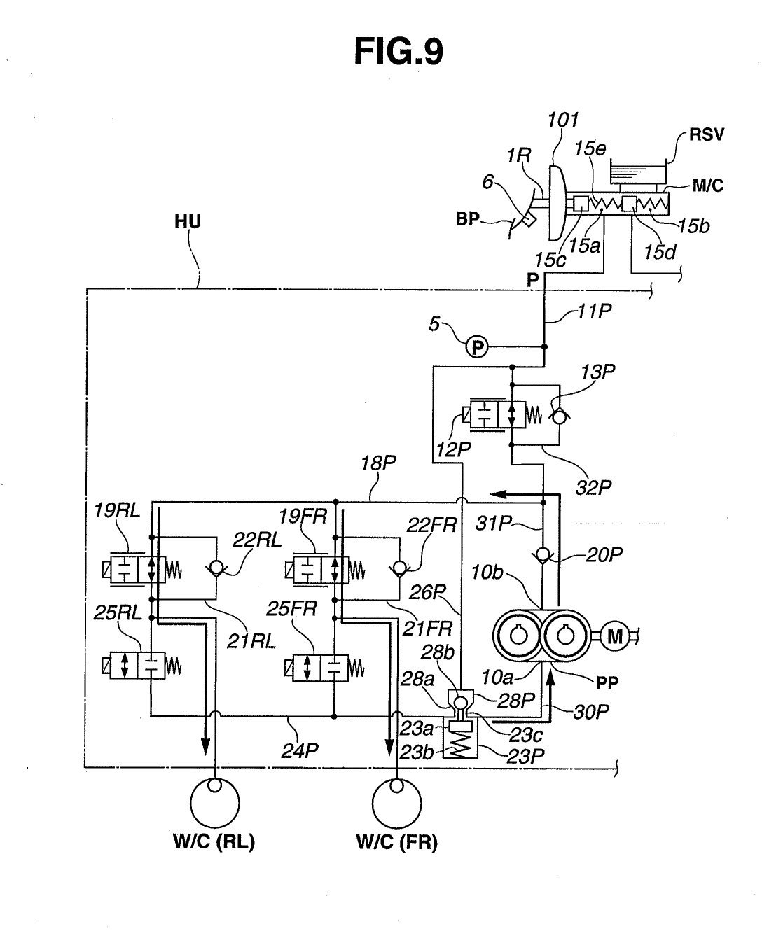

At the time t2, owing to a fall in the maximum regenerative braking force, resulting from the vehicle-speed decrease, the regenerative braking force begins to reduce. Therefore, as appreciated from the brake-fluid flow shown in FIG. 9, within the hydraulic control unit HU the solenoid-out valve 25RL becomes closed and simultaneously the pump P becomes shifted to its drive state (operative state) by speed control for motor M. Brake fluid, stored in the reservoir 23, is delivered to each individual wheel-brake cylinder W/C, and thus it is possible to increase the friction braking force depending on the decrease in regenerative braking force. In this manner, a deviation (a lack) of the regenerative braking force from the driver's required braking force can be compensated for by the friction braking force. At this time, a wheel-cylinder pressure in each individual wheel-brake cylinder W/C has already developed to an appropriate pressure level (an approximately constant pressure level), and thus it is possible to more certainly enhance the responsiveness in the friction-braking-force rise by virtue of a play-elimination effect, obtained by the appropriately-developed wheel-cylinder pressure.

At the time t3, substitution control, by which the regenerative braking force is substituted with the friction braking force, has been completed, and thus motor M has stopped rotating.

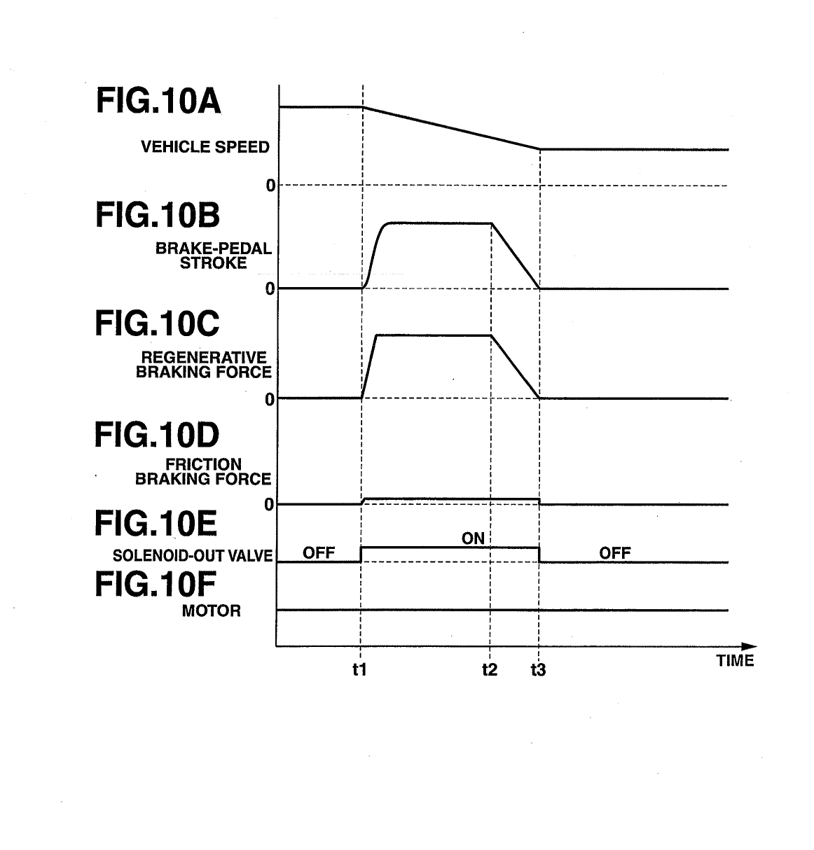

Referring now to FIGS. 10A-10F, there are shown the time charts when the brake pedal BP is released by the driver during energy-regeneration cooperative control.

The control action, executed by the brake control apparatus of the embodiment during the time period (t1-t2) from the time t1 to the time t2 in the time charts of FIGS. 10A-10F, is the same as that of FIGS. 7A-7F.

At the time t2 (i.e., a brake-release point), the brake pedal BP is released by the driver, and thus the regenerative braking force begins to drop.

At the time t3, the brake-pedal stroke becomes zero, and thus the solenoid-out valve 25RL becomes closed.

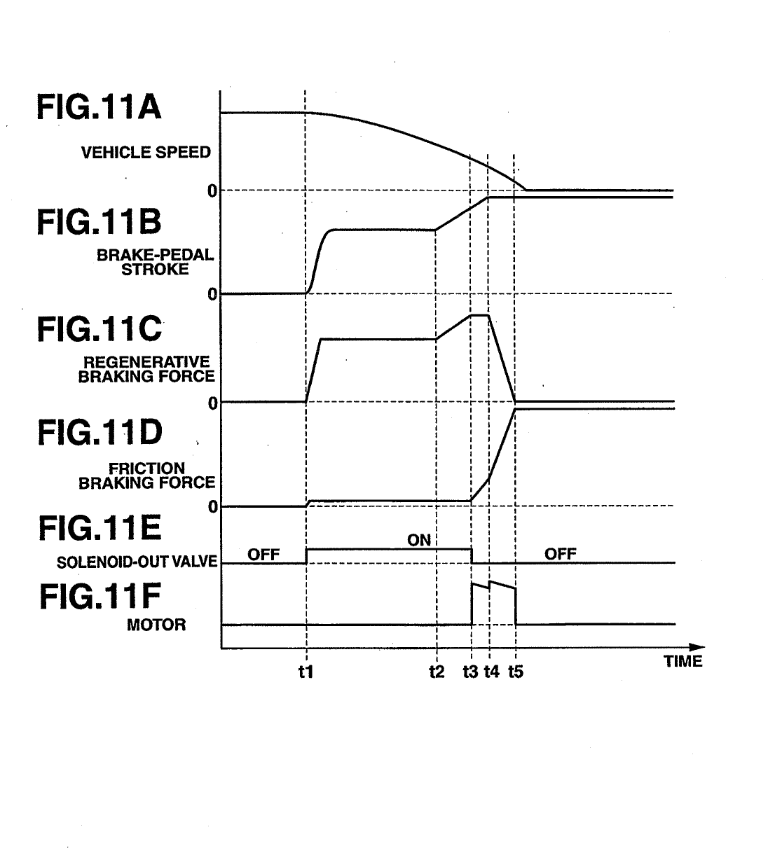

Referring now to FIGS. 11A-11F, there are shown the time charts when the brake pedal BP is further depressed by the driver during energy-regeneration cooperative control.

The control action, executed by the brake control apparatus of the embodiment during the time period (t1-t2) from the time t1 to the time t2 in the time charts of FIGS. 11A-11F, is the same as that of FIGS. 7A-7F.

At the time t2 (i.e., a further brake-pedal-depression point), the brake pedal BP is further depressed by the driver, and thus the regenerative braking force begins to further rise.

At the time t3, the maximum regenerative braking force has been reached. Therefore, as can be seen from the brake-fluid flow of FIG. 9, within the hydraulic control unit HU the solenoid-out valve 25RL becomes closed and simultaneously the pump P becomes shifted to its operative state by speed control for motor M, with the result that brake fluid, stored in the reservoir 23, is delivered to each individual wheel-brake cylinder W/C. Thus, a deviation (a lack) of the regenerative braking force from the driver's required braking force can be compensated for by the friction braking force.

The control action, executed by the brake control apparatus of the embodiment during the time period (t4-t5) from the time t4 to the time t5 in the time charts of FIGS. 11A-11F, is the same as the control action executed during the time period (t2-t3) in the time charts of FIGS. 7A-7F.

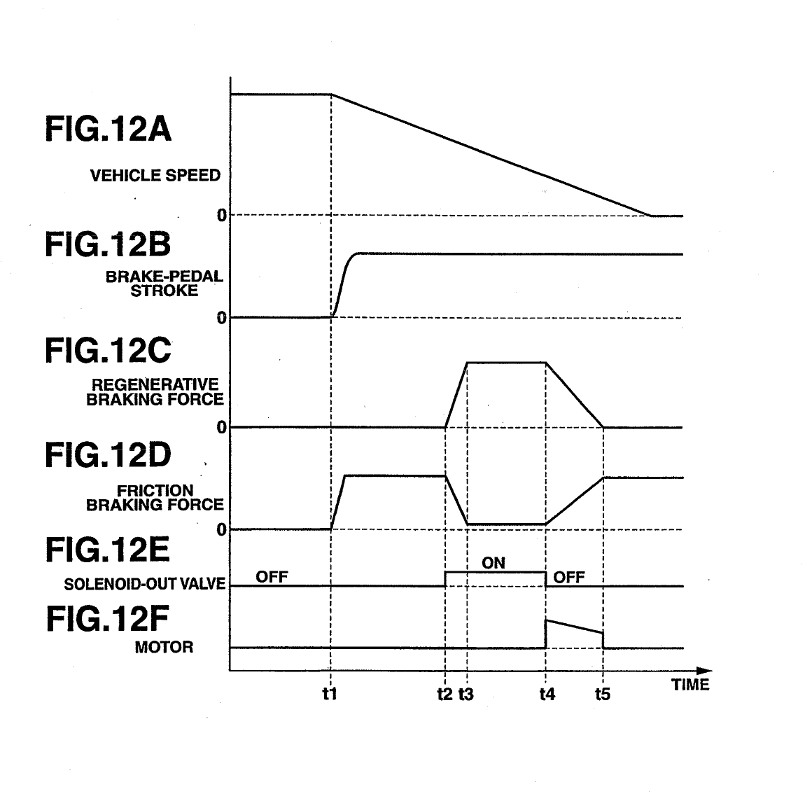

Referring now to FIGS. 12A-12F, there are shown the time charts when the driver is depressing the brake pedal BP in a high-speed range during energy-regeneration cooperative control.

At the time t1, the driver begins to press on the brake pedal BP, but the regenerative braking force is restricted or regenerative braking action is inhibited due to high vehicle speeds, and thus the hydraulic control unit HU operates to supply brake-fluid flow from the master cylinder M/C toward each individual wheel-brake cylinder W/C, such that the driver's required braking force can be achieved by only the friction braking force.

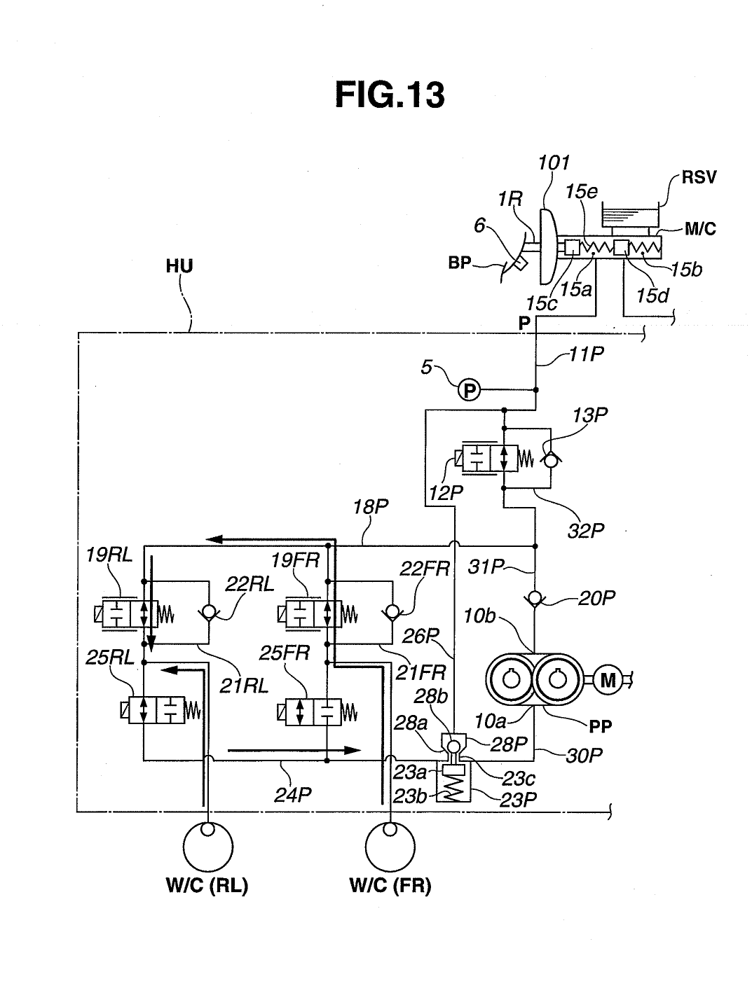

At the time t2, the restriction on the regenerative braking force is relaxed or removed because of a vehicle-speed drop, and as a result the regenerative braking force begins to rise. At this time, as appreciated from the brake-fluid flow shown in FIG. 13, one solenoid-out valve 25RL of the solenoid-out valves 25FR-25RL (belonging to in the same brake-line system) incorporated in the hydraulic control unit HU becomes opened for flowing and storing the outgoing brake fluid, flown out of the master cylinder M/C, into the reservoir 23. Hence, substitution control, by which the friction braking force is substituted with the regenerative braking force, starts from the time t2. Also, at this time, the brake-pedal stroke (i.e., the input-rod stroke L) is within the stroke control region of pneumatic booster 101, and thus the relationship between the brake-pedal stroke and the brake-pedal reaction force can be maintained constant, regardless of the master-cylinder pressure, thereby enabling a good brake-pedal “feel” to be maintained.

At the time t3, substitution control, by which the friction braking force is substituted with the regenerative braking force, has been completed.

The control action, executed by the brake control apparatus of the embodiment during the time period (t4-t5) from the time t4 to the time t5 in the time charts of FIGS. 12A-12F, is the same as the control action executed during the time period (t2-t3) in the time charts of FIGS. 7A-7F.

As explained previously, brake control unit BCU is configured to bring both the gate-out valve 12 and the solenoid-in valve 19 to their non-controlled states (deactivated states) and simultaneously bring only the solenoid-out valve 25 to a controlled state (an activated state), when flowing and storing the brake fluid, flown out of the master cylinder M/C due to the driver's brake-pedal operation, into the reservoir 23 and when flowing and storing the brake fluid in each individual wheel-brake cylinder W/C into the reservoir 23, during operation of the electric-regenerative braking system.

On the other hand, in the case of a general brake control system, when surplus brake fluid has to be stored in a reservoir during operation of an electric-regenerative braking system, a gate-out valve, a solenoid-in valve, and a solenoid-out valve have been brought into their operative states (activated states), for controlling or regulating the wheel-cylinder pressure as well as the master-cylinder pressure. That is, a plurality of valves has to be accurately operated. Such a requirement of high-precision control actions for all of the plurality of valves leads to a deterioration in the total control accuracy in the brake control system.

In contrast, in the case of the brake control apparatus of the embodiment, the hydraulic control unit HU is configured to accurately operate only the solenoid-out valve 25, when surplus brake fluid has to be stored in the reservoir during energy-regeneration cooperative control. Thus, in comparison with the general brake control system, the brake control apparatus of the embodiment ensures the greatly-enhanced control accuracy in the brake control system as a whole.

Furthermore, as described previously, pneumatic booster 101 of the embodiment is configured to have a stroke control region, which is defined as a predetermined brake-pedal stroke range from a driver's brake-pedal operation start point where the driver begins to press on the brake pedal BP to the input-rod stroke S2 corresponding to the input-rod input F3. Within the stroke control region, the reaction force, arising from the master-cylinder pressure developing in the master cylinder M/C, does not act on the brake pedal BP, but only the reaction force, arising from the spring force of reaction spring 159, acts on the brake pedal BP.

Within the stroke control region, the brake control apparatus of the embodiment has a characteristic that the leg-power (i.e., the rod input F) increases as the brake-pedal stroke (i.e., the input-rod stroke L) increases. Hence, the brake control apparatus of the embodiment can provide a good brake-pedal “feel” similar to a brake-pedal “feel” obtained by a conventional brake system.

Additionally, within the stroke control region, the brake control apparatus of the embodiment is further configured to maintain a relationship of the leg-power (i.e., the rod input F) applied to the brake pedal BP to the brake-pedal stroke (i.e., the input-rod stroke L) at a specified characteristic, regardless of the hydraulic pressure in the master cylinder M/C. Hence, the brake control apparatus of the embodiment can provide a good brake-pedal “feel” similar to a brake-pedal “feel” obtained by a conventional brake system.

The brake control apparatus of the embodiment can provide the following effects:

(1) In a brake control apparatus of a vehicle employing (i) a fluid-pressure friction braking system (i.e., hydraulic control unit HU and brake control unit BCU) configured to generate a friction braking force by controlling a pressure of brake fluid in each wheel-brake cylinder W/C installed on road wheels and (ii) an electric-regenerative braking system (i.e., motor generator MG, inverter INV, battery BATT, and motor control unit MCU) configured to generate an electric-regenerative braking force acting on the road wheels, and using both the fluid-pressure friction braking system and the electric-regenerative braking system for braking, the brake control apparatus includes a normally-open solenoid-in valve (a normally-open pressure-buildup control valve) 19 disposed between a master cylinder M/C and each of the wheel-brake cylinders W/C, a reservoir 23 into which the brake fluid in each of the wheel-brake cylinders W/C flows during an anti-brake skid (ABS) pressure-reduction control mode, a solenoid-out valve (a pressure-reduction control valve) 25 disposed between each of the wheel-brake cylinders W/C and the reservoir 23, and a brake control unit (a fluid-pressure controller) BCU configured to bring the solenoid-in valve 19 to a non-controlled state (a deactivated state) and simultaneously bring the solenoid-out valve 25 to a controlled state (an activated state), when flowing and storing the brake fluid, flown out of the master cylinder M/C due to a driver's brake-pedal operation, into the reservoir 23 and when flowing and storing the brake fluid in each of the wheel-brake cylinders W/C into the reservoir 23, during braking with the electric-regenerative braking system brought to an operative state. Hence, it is possible to enhance the control accuracy of the brake control system.

(2) Brake control unit BCU is configured to control only the solenoid-out valve 25. Hence, it is possible to greatly enhance the control accuracy of the brake control system.

(3) Also provided is a pneumatic booster 101 for multiplying an input (in other words, a rod input F) applied to a brake pedal BP by the driver's brake-pedal operation. Pneumatic booster 101 is configured to have a stroke control region, which is defined as a predetermined brake-pedal stroke range from a start point of the driver's brake-pedal operation to a predetermined input-rod stroke S2. Within the stroke control region, the reaction force, arising from the master-cylinder pressure developing in the master cylinder M/C, does not act on the brake pedal BP, but only the reaction force, arising from the spring force of reaction spring 159, acts on the brake pedal BP. Thus, a relationship of the leg-power (in other words, the rod input F) applied to the brake pedal BP to the brake-pedal stroke (in other words, the rod stroke L) can be maintained at a specified characteristic, regardless of the hydraulic pressure in the master cylinder M/C. Hence, within the stroke control region, it is possible to effectively suppress fluctuations in the reaction acting on the brake pedal BP.

(4) Pneumatic booster 101 is further configured such that the leg-power applied to the brake pedal BP increases, as the brake-pedal stroke increases, within the stroke control region. This provides a good brake-pedal “feel”.

(5) Also provided is a pneumatic booster 101 for multiplying an input applied to a brake pedal BP by the driver's brake-pedal operation. Pneumatic booster 101 is configured to have a stroke control region, which is defined as a predetermined brake-pedal stroke range from a start point of the driver's brake-pedal operation to a predetermined input-rod stroke S2. Within the stroke control region, a relationship of the leg-power (i.e., the rod input F) applied to the brake pedal BP to the brake-pedal stroke (i.e., the input-rod stroke L) can be maintained at a specified characteristic, regardless of the hydraulic pressure in the master cylinder M/C. Hence, within the stroke control region, it is possible to provide a good brake-pedal “feel”.

Additionally, the fluid-pressure controller (brake control unit BCU) is configured to bring the pressure-buildup control valve (solenoid-in valve 19) to the non-controlled state and simultaneously bring the pressure-reduction control valve (solenoid-out valve 25) to the controlled state within the previously-discussed stroke control region. Thus, it is possible to always keep a good brake-pedal “feel” during operation of the electric-regenerative braking system.

In the shown embodiment, the brake control apparatus is exemplified in a hybrid vehicle (HV) using both a fluid-pressure friction braking system and an electric-regenerative braking system for braking. In lieu thereof, the brake control apparatus of the embodiment may be applied to an electric vehicle (EV) using both a fluid-pressure friction braking system and an electric-regenerative braking system for braking.

The entire contents of Japanese Patent Application No. 2012-187472 (filed Aug. 28, 2012) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A brake control apparatus of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control apparatus comprising:
a normally-open pressure-buildup control valve disposed between a master cylinder and each of the wheel-brake cylinders;
a reservoir into which the brake fluid in each of the wheel-brake cylinders flows during an anti-brake skid pressure-reduction control mode;
a pressure-reduction control valve disposed between each of the wheel-brake cylinders and the reservoir; and
a fluid-pressure controller configured to bring the pressure-buildup control valve to a non-controlled state and simultaneously bring the pressure-reduction control valve to a controlled state, when flowing and storing the brake fluid, flown out of the master cylinder due to a driver's brake-pedal operation, into the reservoir and when flowing and storing the brake fluid in each of the wheel-brake cylinders into the reservoir, during braking with the electric-regenerative braking system brought to an operative state.

2. The brake control apparatus as claimed in claim 1, wherein:
the fluid-pressure controller is configured to control only the pressure-reduction control valve.

3. The brake control apparatus as claimed in claim 1, which further comprises:
a pneumatic booster for multiplying an input applied to a brake pedal by the driver's brake-pedal operation,
wherein the pneumatic booster is configured to have a stroke control region, which is defined as a predetermined brake-pedal stroke range from a start point of the driver's brake-pedal operation to a predetermined input-rod stroke and within which a relationship of a leg-power applied to the brake pedal to a brake-pedal stroke can be maintained at a specified characteristic.

4. The brake control apparatus as claimed in claim 3, wherein:
the pneumatic booster is further configured such that the leg-power applied to the brake pedal increases, as the brake-pedal stroke increases, within the stroke control region.

5. The brake control apparatus as claimed in claim 1, which further comprises:
a pneumatic booster for multiplying an input applied to a brake pedal by the driver's brake-pedal operation,
wherein the pneumatic booster is configured to have a stroke control region, which is defined as a predetermined brake-pedal stroke range from a start point of the driver's brake-pedal operation to a predetermined input-rod stroke and within which a relationship of a leg-power applied to the brake pedal to a brake-pedal stroke can be maintained at a specified characteristic, regardless of a pressure in the master cylinder.

6. The brake control apparatus as claimed in claim 5, wherein:
the fluid-pressure controller is configured to bring the pressure-buildup control valve to the non-controlled state and simultaneously bring the pressure-reduction control valve to the controlled state within the stroke control region.

7. The brake control apparatus as claimed in claim 6, wherein:
the fluid-pressure friction braking system is configured to produce an approximately constant wheel cylinder pressure due to the driver's brake-pedal operation within the stroke control region.

8. The brake control apparatus as claimed in claim 1, wherein:
the fluid-pressure controller is configured to permit the brake fluid, flown out of the master cylinder due to the driver's brake-pedal operation, to be directed to the reservoir, when braking with the electric-regenerative braking system brought to the operative state after the driver's brake-pedal operation has started.

9. The brake control apparatus as claimed in claim 1, wherein:
the fluid-pressure controller is configured to permit the brake fluid in each of the wheel-brake cylinders to be directed to the reservoir, when the electric-regenerative braking force, generated by the electric-regenerative braking system increases, while the friction braking force, generated by the fluid-pressure friction braking system, decreases, during the driver's brake-pedal operation.

10. The brake control apparatus as claimed in claim 1, wherein:
a plurality of sets of the wheel-brake cylinder, the pressure-reduction control valve and the normally-open pressure-buildup control valve are disposed in each brake-line system; and
as for the reservoir, only one reservoir is disposed in each of the brake-line systems,
wherein the fluid-pressure controller is configured to permit the brake fluid in each of the wheel-brake cylinders to be directed to the reservoir by opening a specified one of the pressure-reduction control valves, the specified pressure-reduction control valve being disposed between the reservoir and a specified wheel-brake cylinder of the wheel-brake cylinders, for the same brake-line system.

11. A brake control apparatus of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control apparatus comprising:
a pump disposed in a hydraulic brake circuit;
a first brake circuit configured to connect a master cylinder provided for generating a brake-fluid pressure due to a driver's brake-pedal operation to each of the wheel-brake cylinders configured such that the brake-fluid pressure, generated by the master cylinder, acts on each of the wheel-brake cylinders;
a second brake circuit configured to connect the first brake circuit to a discharge port of the pump;
a normally-open gate-out valve disposed in the first brake circuit between the master cylinder and a joining point of the first brake circuit and the second brake circuit;
a third brake circuit configured to connect a point of the first brake circuit between the normally-open gate-out valve and the master cylinder to an inlet port of the pump;
a normally-open pressure-buildup control valve disposed in the first brake circuit between each of the wheel-brake cylinders and the joining point of the first brake circuit and the second brake circuit;
a fourth brake circuit configured to connect a point of the first brake circuit between each of the wheel-brake cylinders and the normally-open pressure-buildup control valve to the inlet port of the pump;
a normally-closed pressure-reduction control valve disposed in the fourth brake circuit;
a reservoir disposed in the fourth brake circuit between the inlet port of the pump and the normally-closed pressure-reduction control valve, and configured to connected to the third brake circuit; and
a fluid-pressure controller configured to permit the brake fluid, flown out of the master cylinder due to the driver's brake-pedal operation, and the brake fluid in each of the wheel-brake cylinders to be directed to the reservoir, by controlling only the normally-closed pressure-reduction control valve of these valves, during braking with the electric-regenerative braking system brought to an operative state.

12. The brake control apparatus as claimed in claim 11, which further comprises:
a pneumatic booster for multiplying an input applied to a brake pedal by the driver's brake-pedal operation,
wherein the pneumatic booster is configured to have a stroke control region, which is defined as a predetermined brake-pedal stroke range from a start point of the driver's brake-pedal operation to a predetermined input-rod stroke and within which a relationship of a leg-power applied to the brake pedal to a brake-pedal stroke can be maintained at a specified characteristic.

13. The brake control apparatus as claimed in claim 11, which further comprises:
a pneumatic booster for multiplying an input applied to a brake pedal by the driver's brake-pedal operation,
wherein the pneumatic booster is configured such that the leg-power applied to the brake pedal increases, as the brake-pedal stroke increases, within the stroke control region.

14. The brake control apparatus as claimed in claim 11, which further comprises:
a pneumatic booster for multiplying an input applied to a brake pedal by the driver's brake-pedal operation,
wherein the pneumatic booster is configured to have a stroke control region, which is defined as a predetermined brake-pedal stroke range from a start point of the driver's brake-pedal operation to a predetermined input-rod stroke and within which a relationship of a leg-power applied to the brake pedal to a brake-pedal stroke can be maintained at a specified characteristic, regardless of a pressure in the master cylinder.

15. The brake control apparatus as claimed in claim 11, wherein:
the fluid-pressure controller is configured to permit the brake fluid, flown out of the master cylinder due to the driver's brake-pedal operation, to be directed to the reservoir, when braking with the electric-regenerative braking system brought to the operative state after the driver's brake-pedal operation has started.

16. The brake control apparatus as claimed in claim 15, wherein:
the fluid-pressure controller is configured to permit the brake fluid in each of the wheel-brake cylinders to be directed to the reservoir, when the electric-regenerative braking force, generated by the electric-regenerative braking system increases, while the friction braking force, generated by the fluid-pressure friction braking system, decreases, during the driver's brake-pedal operation.

17. The brake control apparatus as claimed in claim 16, wherein:
a plurality of sets of the wheel-brake cylinder, the pressure-reduction control valve and the normally-open pressure-buildup control valve are disposed in each brake-line system; and
as for the reservoir, only one reservoir is disposed in each of the brake-line systems,
wherein the fluid-pressure controller is configured to permit the brake fluid in each of the wheel-brake cylinders to be directed to the reservoir by opening a specified one of the pressure-reduction control valves, the specified pressure-reduction control valve being disposed between the reservoir and a specified wheel-brake cylinder of the wheel-brake cylinders, for the same brake-line system.

18. A brake control method of a vehicle employing a fluid-pressure friction braking system configured to generate a friction braking force by controlling a pressure of brake fluid in each wheel-brake cylinder installed on road wheels and an electric-regenerative braking system configured to generate an electric-regenerative braking force acting on the road wheels, and using both the fluid-pressure friction braking system and the electric-regenerative braking system for braking, the brake control method comprising:
driving one control valve when flowing and storing the brake fluid, flown out of the master cylinder due to a driver's brake-pedal operation, into a reservoir.

19. The brake control method as claimed in claim 18, wherein:
only the one control valve is driven when flowing and storing the brake fluid in each of the wheel-brake cylinders into the reservoir.

20. The brake control method as claimed in claim 19, wherein:
the one control valve is a pressure reduction control valve disposed between an associated one of the wheel-brake cylinders and the reservoir.
